(19) United States
(12) Patent Application Publication
(10) Pub. No.: US 2002/0028321 A1
(43) Pub. Date: Mar. 7, 2002

(54) Method of printing scratch-off material and resulting product

(76) Inventors: Michael A. Feilen SR., Elgin, IL (US); Jordan D. Mann, Schaumburg, IL (US)

Correspondence Address: Wallenstein & Wagner, Ltd, 311 S. Wacker Drive, 53rd Floor, Chicago, IL, 60606-6630, US

(21) Appl. No.: 09/853,949

(22) Filed: May 11, 2001

Related U.S. Application Data
(60) Provisional application No. 60/203,194, filed on May 11, 2000.

(51) Int. Cl. B32B 3/00; B32B 7/14

(52) U.S. Cl. 428/201

(57) ABSTRACT

The present invention provides a method for printing scratch-off material on a substrate with off-set printing equipment, and the resulting product. First, an indicia is printed on an upper surface of a substrate. Next, an aqueous ultraviolet primer layer is applied over the substrate and the indicia. The primer layer seals the upper surface of the substrate and facilitates the application of a subsequent ultraviolet coating layer. After the primer layer has cured, an ultraviolet coating layer is applied over the primer layer. After the ultraviolet coating has cured, a first semi-opaque scratch-off layer is applied over the ultraviolet coating with offset equipment to form a high quality image. The first scratch-off layer should be formulated such that it dries on the ultraviolet coating, but does not adhere to the ultraviolet coating. In another aspect of the invention, a second layer of scratch-off material can be applied over the first scratch-off layer after it has cured. Tints can be added to the ink in the second scratch-off layer to add color to the second scratch-off layer in order to further differentiate it from the first layer. Depending on the intensity of the colors on the substrate, the indicia, and the first scratch-off layer, multiple passes through the offset equipment could be required to properly apply either of the scratch-off layers. In addition, either scratch-off layer can include metallic ink to make the scratch-off layers more noticeable.

### RELATED APPLICATIONS

This application claims priority from provisional application serial No. 60/203,194 filed May 11, 2000.

### FEDERALLY SPONSORED RESEARCH OR DEVELOPMENT

Not applicable.

### TECHNICAL FIELD

The present invention relates generally to a method of printing scratch-off material. More particularly, the present invention relates to a method of printing a single layer or multiple layers of scratch-off material with offset printing equipment.

### BACKGROUND OF THE INVENTION

Scratch-off material is an opaque layer used to cover indicia on a substrate. Generally, the opaque layer is removed by scratching off the material, thus revealing the indicia on the substrate. An example of the use of scratch-off material is lottery tickets, in which a coin is used to remove the scratch-off material to reveal an indicia that determines whether the lottery ticket is a winning ticket. In lottery tickets and other conventional print applications, the scratch-off material is silk screened directly onto the substrate surface over the indicia.

Silk screening is a form of serigraphic printing, consisting of forcing an ink through a mesh screen stretched on a frame above the object to be printed. The mesh screen contains printing and non-printing areas. The non-printing areas are defined by the application of a stencil or by blocking the area. The silk screening process includes the following time consuming steps: positioning the object to be printed; moving the frame and screen coincident to the object; applying ink to the screen; spreading and forcing the ink through the screen and onto the object; and, removing the printed object and placing it in a drying apparatus.

Although semiautomatic and automatic machines have been used with limited success, silk screen printing continues to be primarily done by hand, with the frame being lifted up after each operation. As a result, printing scratch-off material with the silk-screening process is extremely time consuming and inefficient. In addition, the silk screening process is expensive in both labor costs and equipment costs. Even when semiautomatic and automatic machines are used in the silk screening process, output is limited to about 6,000 copies per hour.

Due to the limitations of silk screening, scratch-off material has not been fully utilized in applications beyond lottery tickets, such as commercial print and advertising. Consequently, there is a definite need for a more efficient and automated process to print high quality single and multiple layers of scratch-off material at increased output volumes.

### SUMMARY OF THE INVENTION

The present invention relates to a method of printing scratch-off material with offset printing equipment. The present invention further relates to printing either a single layer or multiple layers of scratch-off material with offset printing equipment, where each layer of scratch-off can be a different color.

Offset printing is a printing technique where an inked image on a printing plate is printed on a rubber cylinder and then transferred (i.e., offset) to paper. In comparison to silk screening and other printing methods, offset printing has a higher production rate (up to 10,000 sheets per hour) and generates a higher quality printed image. Also, offset printing equipment requires less labor and is cheaper to operate and maintain.

An attribute of offset printing is that the ink is not transferred directly from the printing plate to the paper; instead, the ink is transferred to a rubber blanket cylinder. The rubber blanket cylinder retains the ink and then transfers it to the paper. Another attribute of offset printing is a metal printing plate with a single continuous surface with distinct printing and non-printing areas. The printing areas of the surface repel water but absorb ink. In contrast, the non-printing areas of the surface absorb water but reject ink.

Modern offset printing equipment includes three rotating cylinders: a plate cylinder, to which the metal plate is affixed; a blanket cylinder covered with a layer of rubber; and, an impression cylinder that positions the paper against the blanket cylinder. Generally, the three rotating cylinders are of the same diameter and rotate at the same speed. The rotation of the cylinders is synchronized by meshing sprocket wheels.

In operation, the plate cylinder comes into contact with a series of moistening rollers that deposit moisture onto granulations in the surface of the metal plate. Next, the plate cylinder comes into contact with a series of inking rollers that apply ink to the surface of the metal plate to form the printing image. Specifically, the printing image is formed as the printing areas absorb the ink and the non-printing areas reject the ink. The printing image is then transferred from the plate cylinder to the rubber surface of the blanket cylinder. Lastly, the printing image is transferred, or offset, to paper positioned about the impression cylinder and fed by a feeding system.

According to one aspect of the invention, the method is directed to offset printing a single layer of scratch-off material. First, an indicia is printed on a surface of a substrate with ink that is compatible with a subsequent ultraviolet coating layer. Next, an aqueous ultraviolet primer layer is applied over the substrate and the indicia. Essentially, the primer layer seals the substrate surface and facilitates the application of a subsequent ultraviolet coating layer. A layer of ultraviolet coating is then applied over the primer layer. The ultraviolet coating layer is a light sensitive, chemical-based product that is preferably applied with offset equipment. Next, a single layer of semi-opaque scratch-off is applied over the ultraviolet coating layer with offset equipment to form a high quality image. Depending on the intensity of the colors on the substrate and the indicia, multiple passes through the offset equipment could be required to form the single layer of scratch-off material.

According to another aspect of the invention, the method is directed to offset printing multiple layers of different colored scratch-off material. First, an indicia is printed on a surface of a substrate with ink that is compatible with a subsequent ultraviolet coating layer. Next, an aqueous ultraviolet primer layer is applied over the substrate and the indicia. A layer of ultraviolet coating is then applied over the primer layer. Next, a first layer of opaque scratch-off is applied over the ultraviolet coating layer with offset equipment. Although the preferred color of the first scratch-off layer is white, tints can be added to the ink to add color to this layer. Depending on the intensity of the colors on the substrate and the indicia, multiple passes through the offset equipment could be required for the first scratch-off layer. A second scratch-off layer is then applied over the first scratch-off layer with offset equipment to form a high quality image. Depending on the intensity of the colors on the substrate, the indicia, and the first layer of scratch-off, multiple passes through the offset equipment could be required for the second scratch-off layer.

### BRIEF DESCRIPTION OF THE DRAWINGS

FIG. 1 is a perspective view of the product of the invention;

FIG. 2 is an exploded view of the product including the substrate, the primer layer, the ultraviolet coating layer, and the first scratch-off layer;

FIG. 3 is a perspective view of an alternate embodiment of the product; and

FIG. 4 is an exploded view of the alternate embodiment of the product showing the substrate, the primer layer, the ultraviolet coating layer, the first scratch-off layer, and the second scratch-off layer.

### DETAILED DESCRIPTION OF THE PREFERRED EMBODIMENT

While the invention is susceptible of embodiment in many different forms, there is shown in the drawings and will herein be described in detail a preferred embodiment of the invention. It is to be understood that the present disclosure is to be considered as an exemplification of the principles of the invention. This disclosure is not intended to limit the broad aspects of the invention to the illustrated embodiments.

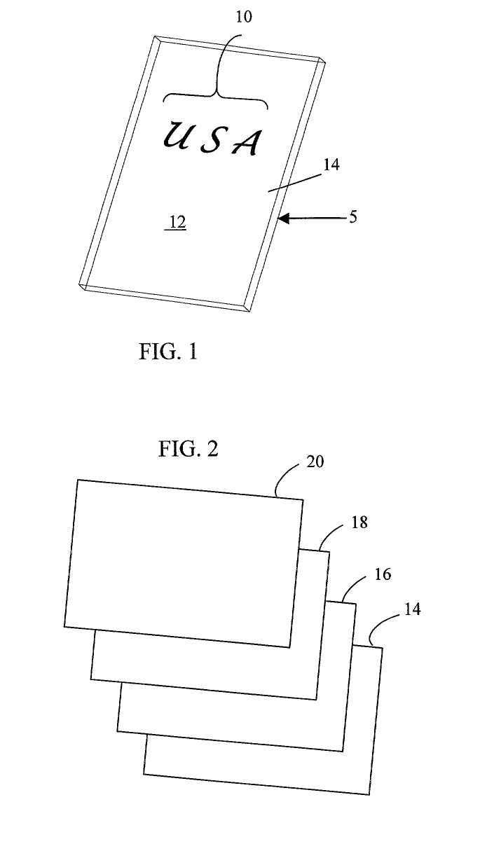

The present invention provides a method for printing a single layer of scratch-off material with offset printing equipment, and the resulting product. Referring to FIG. 1, the resulting printed product 5 is shown with an indicia 10 printed on an upper surface 12 of a substrate 14. The ink used to print the indicia 10 is compatible with a subsequent ultraviolet coating layer. The indicia 10 can be printed with any conventional printing method; however, the offset printing method is preferred because of its higher output rates and better image quality. As an alternative to printing the indicia 10, the substrate 14 can be supplied with the indicia 10 pre-printed.

Referring to FIG. 2, an aqueous ultraviolet primer layer 16 is then applied over the substrate 14 and the indicia 10. The primer layer 16 seals the upper surface 12 of the substrate 14 and facilitates the application of a subsequent ultraviolet coating layer. The primer layer 16 can be applied with any conventional method, but offset printing is the preferred method. After the primer layer 16 has cured, an ultraviolet coating layer 18 is applied over the primer layer 16. The ultraviolet coating layer 18 is a light-sensitive layer that is preferably applied with offset equipment. The inks used in both the indicia 10 and the primer layer 16 should be compatible with the ultraviolet characteristics of the ultraviolet coating layer 18. This means that the inks should be wax-free and color-fast. In contrast, the ultraviolet coating layer 18 can include a wax component (not shown), which can function as an added barrier between the ultraviolet coating layer 18 and subsequent scratch-off layers. After the ultraviolet coating 18 has cured, a scratch-off layer 20 is applied over the ultraviolet coating 18 with offset equipment. The scratch-off layer 20 can be either opaque or semi-opaque, the later meaning that some light will pass through the scratch-off layer 20. Once the scratch-off layer 20 has sufficiently cured, the printed product 5 results. The product 5 can then be packaged or shipped.

Applying the scratch-off layer 20 with offset equipment ensures a high quality image and higher product output rates. The inks used in the scratch-off layer 20 should be formulated such that the layer 20 dries on the ultraviolet coating 18, but not in a permanent manner. This means that the scratch-off layer 20 should not become permanently affixed to or adhered to the ultraviolet coating 18. If the scratch-off layer 20 adheres to the ultraviolet coating 18, then it cannot be removed and the purpose of the scratch-off layer 20 is negated and the effectiveness of the product 5 is reduced. The scratch-off layer 20 can be removed by applying a removal force, Fᵣ, sufficient to dislodge and release the layer 20. The removal force, Fᵣ, can be generated in a number of ways, including but not limited to rubbing the layer 20 with a coin or metallic object.

Although the preferred color of the scratch-off layer 20 is white, various tints can be added to the ink in the scratch-off layer 20 to add color to this layer. The scratch-off layer 20 can include metallic ink, such as gold or silver ink, which can make the scratch-off layer 20 more noticeable or prominent. The amount of metallic ink in the scratch-off layer 20 can vary greatly; however, a common range is between 3 and 7 percent, by either weight or volume.

Depending on the brightness and intensity of the colors on both the substrate 14 and the indicia 10, multiple passes through the offset printing equipment can be required. This means that for bright substrate and/or indicia colors, multiple passes might be necessary to produce a scratch-off layer 20 that adequately covers the substrate 14 and indicia 10.

The configuration and dimensions of the scratch-off layer 20 can be adapted to cover a portion of, or the entire indicia 10. This means that the scratch-off layer 20 can be selectively applied to just the indicia 10 or to the surrounding background.

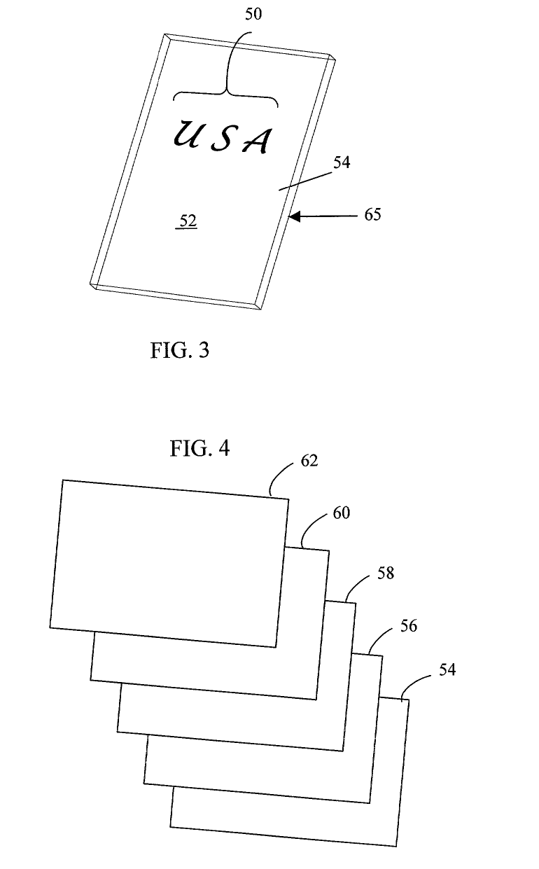

In another embodiment, the invention provides a method for printing multiple layers of scratch-off material with offset printing equipment, and the resulting printed product 65. Referring to FIG. 3, an indicia 50 is printed on an upper surface 52 of a substrate 54. The ink used to print the indicia 50 is compatible with a subsequent ultraviolet coating layer. Referring to FIG. 4, an aqueous ultraviolet primer layer 56 is then applied over the substrate 54 and the indicia 50. The primer layer 56 seals the upper surface 52 of the substrate 54 and facilitates the application of a subsequent ultraviolet coating layer. The primer layer 56 can be applied with any conventional method, but offset printing is the preferred method. After the primer layer 56 has cured, an ultraviolet coating layer 58 is applied over the primer layer 56. The ultraviolet coating layer 58 is a light-sensitive layer that is preferably applied with offset equipment. The inks used in both the indicia 50 and the primer layer 56 should be compatible with the ultraviolet characteristics of the coating layer 58. This means that the inks should be wax-free and color-fast. In contrast, the ultraviolet coating layer 58 can include a wax component (not shown), which can function as an added barrier between the ultraviolet coating layer 58 and subsequent scratch-off layers.

After the ultraviolet coating 58 has cured, a first scratch-off layer 60 is applied over the ultraviolet coating 58 with offset equipment. The first scratch-off layer 60 can be either opaque or semi-opaque. Although the preferred color of the first scratch-off layer 60 is white, various tints can be added to the ink in the first scratch-off layer 60 to add color to the layer. Depending on the intensity of the colors on the substrate 54 and the indicia 50, multiple passes through the offset equipment could be required to apply the first scratch-off layer 60.

After the first scratch-off layer 60 has cured, a finishing layer or second scratch-off layer 62 is applied over the first scratch-off layer 60 with offset equipment. Various tints can be added to the ink in the second scratch-off layer 62 to add color to the second layer 62 to either differentiate it from or match it to the first layer 60. The second scratch-off layer 62 can be opaque; however, the second layer 62 is preferably semi-opaque to permit a user to see the first scratch-off layer 60 below. Once the second scratch-off layer 62 has sufficiently cured, the printed product 65 results. The product 65 can then be packaged or shipped.

Depending on the intensity of the colors on the substrate 54, the indicia 50, and the first scratch-off layer 60, multiple passes through the offset equipment could be required to apply the second scratch-off layer 62. Furthermore, additional scratch-off layers can be applied with offset equipment over the first and second layers 60, 62.

The inks used in the first and second layers 60, 62 should be formulated such that these layers 60, 62 dry on the ultraviolet coating 58, but not in a permanent manner. This means that these layers 60, 62 should not become permanently affixed to or adhered to the ultraviolet coating 58. In other words, the layers 60, 62 are releasably positioned on the underlying structure, including the ultraviolet coating 58. If the layers 60, 62 adhere to the coating 58, then they cannot be easily removed and the effectiveness of the product 65 is reduced. The scratch-off layers 60, 62 can be removed by applying a removal force, Fᵣ, sufficient to dislodge and release the layers 60, 62. The removal force, Fᵣ, can be generated in a number of ways, including but not limited to rubbing the layers 60, 62 with a coin or metallic object.

The scratch-off layers 60, 62 can include metallic ink, such as gold or silver ink, which can make the scratch-off layers 60, 62 more noticeable or prominent. The amount of metallic ink in the scratch-off layers 60, 62 can vary greatly; however, a common range is between 3 and 7 percent, by either weight or volume.

To ensure that the scratch-off layers 20, 60, 62 will cover the indicia 10, 50, the substrate 14, 54 should have a minimum stock thickness of 0.005 inch. Paper stock is the preferred type of substrate 14, 54. If the substrate 14, 54 is an intermediate security item, the substrate 14, 54 should have a minimum stock thickness of 0.01 inch. If the substrate 14, 54 is a high security item, for example a lottery ticket, the substrate 14, 54 should be a dead white version, which prevents the indicia 10, 50 from being seen when the substrate 14, 54 is held up to a light source.

The ink in the scratch-off layers 20, 60, 62 is specially designed and formulated such that it will dry on the ultraviolet coating layers 18, 58 without adhering to it. Also, the ink in the scratch-off layers 20, 60, 62 can include a metallic component to enhance the masking properties of the ink. The metallic inks can include an additive which helps to prevent the scratch-off layers 20, 60, 62 from adhering to the substrate 14, 54. Depending upon the requirements of the final printed product, waxes can be added to the ink in the scratch-off layers 20, 60, 62 to give the ink better rub characteristics. The waxes can also vary the adhesion of the scratch-off layers 20, 60, 62 to the substrate 14, 54.

To control the drying of the ink in the scratch-off layers 20, 60, 62, caster oil can be added to the ink. Caster oil helps to facilitate the drying process such that the ink remains elastic and does not dry to the point of being brittle. The elastic characteristic of the ink aids in the removal of the scratch-off layers 20, 60, 62. Caster oil is not added to conventional inks in other commercial printing processes because they require the ink to dry as hard as possible and not be elastic. The amount of caster oil can range between 3 and 7 percent, as measured by either weight or volume.

Rice starch is another additive that helps bind the pigments to the varnishes in the ink and also helps to prevent the layers 20, 60, 62 from sticking together during the offset printing process.

The following tables provide information on the components of seven types of ink used in the scratch-off layers 20, 60, 62 with the disclosed method.

TABLE 1
Opaque White

| Component | Amount, % |
|---|---|
| Varnish, SRP561 | 26.75 |
| Varnish, KB300 | 11.50 |
| Varnish, KB117 | 16.0 |
| Titantium Dioxide, TO2 | 42.0 |
| Wax, Polyteck 500 | 3.0 |
| Reducing Oil, Tung Oil | 0.75 |
| Binder Anti-Offset, Rice Starch | 2.33 |
| Drying Activator, Drier X | 0.43 |
| Drier, Cobalt | 0.83 |
| Drier, Grafo | 0.83 |
| Reducing Oil, 52 Oil | 2.33 |

TABLE 2
Metallic Gold

| Component | Amount |
|---|---|
| Low Energy Varnish, 9326 | 24.0 |
| Varnish, 1695-4 | 20.90 |
| Hi Solid Micro Wax, CC-6000D | 4.0 |
| Pigment, Pale Gold Paste | 6.80 |
| Pigment, Rich Gold Paste | 26.50 |
| Pigment, Y-5367 | 7.0 |
| Drier, Cobalt | 1.0 |
| Drier, 2-way | 3.0 |
| Caster Oil | 20 |

TABLE 3
Metallic Silver

| Component | Amount |
|---|---|
| Low Energy Varnish, 9326 | 67.69 |
| Color, Silver Paste | 20.0 |
| Hi Solid Micro Wax, CC-600D | 5.77 |
| Drier, Cobalt | 0.44 |
| Drier, Grapho | 1.10 |
| Caster Oil | 2.0 |

TABLE 4
Black

| Component | Amount |
|---|---|
| Varnish, 300 | 7.50 |
| Varnish, 752 | 24.455 |
| Anti-Offset Compound, X5100 | 2.55 |
| Aluminum Hydrate, KC 350 | 0.99 |
| Black Pigment, 40+ | 24.20 |
| Black Pigment, SW6305 | 22.96 |
| Thalo Blue Pigment, BP6101 | 7.38 |
| Rubine Red Pigment, RR6280 | 2.08 |
| Anti-Oxidant, A34637 | 0.99 |
| Wax, Polytech 500 | 5.0 |
| Acid Powder, Buffer | 0.75 |
| Drier, 2-way | 3.0 |
| Water Fighter, Optilith | 1.0 |
| PMS 877, Silver | 4.83 |
| Caster Oil | 2.0 |

TABLE 5
Process Red

| Component | Amount |
|---|---|
| Varnish, AXQ2236 | 13.25 |
| Varnish, KB752 | 23.35 |
| Pigment, RR6280 | 50.0 |
| Aluminum Hydrate, KC350 | 3.0 |
| Anti-Oxidant, A34637 | 2.0 |
| Wax, Polytech 500 | 5.0 |
| Acid Powder, Buffer | 0.15 |
| Drier, 2-way | 1.25 |
| PMS 877, Silver | 4.83 |
| Caster Oil | 2.0 |

TABLE 6
Process Yellow

| Component | Amount |
|---|---|
| Varnish, AXQ2236 | 7.50 |
| Varnish, KB752 | 46.65 |
| Pigment, YX6236 | 27.63 |
| Aluminum Hydrate, KC350 | 3.0 |
| Anti-Oxidant, A34637 | 2.0 |
| Wax, Polytech 500 | 3.0 |
| Water Figher, Optilith | 0.60 |
| Acid Powder, Buffer | 0.15 |
| Reducing Oil, 52012 | 4.47 |
| PMS 877, Silver | 4.83 |
| Caster Oil | 2.0 |

TABLE 7
Process Blue

| Component | Amount |
|---|---|
| Varnish, 1695-4 | 50.63 |
| Anti-Offset, X5-100 | 2.06 |
| Blue Pigment, BQ-2173 | 35.44 |
| Anti-Oxidant, A34637 | 2.06 |
| Wax, Polytech 500 | 2.0 |
| Water Fighter, Optilith | 1.0 |
| Gelant, Aerosil | 0.63 |
| Drier, 2-Way | 3.0 |
| PMS 877, Silver | 4.83 |
| Reducing Oil, 52-Oil | 0.18 |
| Caster Oil | 2.0 |

Although ambient drying can be used to dry or cure the various layers, infrared driers or other conventional drying systems can be used to reduce the drying process. The ultraviolet coating layers 18, 58 can be dried in a number of ways, including but not limited to light or heat cure. The scratch-off layers 20, 60, 62 can be dried in a number of ways, including but not limited to ambient, forced air, or ultraviolet methods.

Typically, the indicia 10, 50 is located in only a portion of the upper surface 12, 52 of the substrate 14, 54. In this situation, the scratch-off layers 20, 60, 62 can be selectively applied with offset equipment to precisely cover only the indicia. Alternatively, the scratch-off layers 20, 60, 62 can be applied with offset equipment to cover the entire upper surface 12, 52. In contrast to the previous situation, if the indicia 10, 50 covers the entire upper surface 12, 52 of the substrate 14, 54, then the scratch-off layers 20, 60, 62 can be applied with offset equipment to cover the entire upper surface 12, 52.

In order to limit the number of passes though the offset equipment and reduce the production costs, the scratch-off layers 20, 60, 62 should be color coordinated. The density of the color in the substrate 13, 54 areas requiring scratch-off layers 20, 60, 62 should also be evaluated. Indicia areas with dense, rich colors and reversed white type cause the most difficulty and multiple scratch-off layers 20, 60, 62 can be required to cover these types of lower layers. Trapping between colors on the first scratch-off layer 60 is not critical and normal trapping that is used throughout the industry is acceptable. In general, the second scratch-off layer 62 and any subsequent scratch-off layer must be trapped to the first scratch-off layer 60 such that the layers 60, 62 are not displaced by any additional passes through the offset equipment.

While specific embodiments have been illustrated and described, numerous modifications are possible without departing from the spirit of the invention.

We claim:

1. A method of printing scratch-off material, comprising the steps of:
providing a substrate having an upper surface;
printing an indicia on the upper surface;
curing the indicia;
applying a layer of ultraviolet primer over the substrate and indicia;
curing the ultraviolet primer layer;
applying a layer of ultraviolet coating over the ultraviolet primer layer;
curing the ultraviolet coating layer; and,
applying a layer of scratch-off material over the ultraviolet coating layer.

2. The method of claim 1 wherein offset-printing equipment is used to apply the layer of scratch-off material.

3. The method of claim 1 wherein the layer of scratch-off material is composed of varnish, wax, reducing oil, rice starch, driers, pigments, and a drying activator.

4. A printed product having a layer of scratch-off material produced by the method of claim 1.

5. A method of printing scratch-off material with off-set printing equipment, comprising the steps of:
providing a substrate having an upper surface with an indicia thereon;
applying a layer of ultraviolet primer over the substrate and indicia;
curing the ultraviolet primer layer;
applying a layer of ultraviolet coating over the ultraviolet primer layer;
curing the ultraviolet coating layer; and,
applying a layer of scratch-off material over the ultraviolet coating layer.

6. A printed product having a layer of scratch-off material produced by the method of claim 5.

7. The method of claim 5 wherein the layer of scratch-off material is composed of varnish, wax, reducing oil, rice starch, driers, pigments, and a drying activator.

8. A method of printing scratch-off material with off-set printing equipment, comprising the steps of:
providing a substrate having an upper surface with an indicia thereon;
applying a layer of ultraviolet primer over the substrate and indicia with off-set printing equipment;
curing the ultraviolet primer layer;
applying a layer of ultraviolet coating over the ultraviolet primer layer with off-set printing equipment;
curing the ultraviolet coating layer;
applying a first layer of scratch-off material over the ultraviolet coating layer with off-set printing equipment;
curing the first layer of scratch-off material; and,
applying a second layer of scratch-off material over the first layer of scratch-off material with off-set printing equipment.

9. A printed product having a first and a second layer of scratch-off material produced by the method of claim 8.

10. The method of claim 8 wherein the first and second layers of scratch-off material are composed of varnish, wax, reducing oil, rice starch, driers, pigments and a drying activator.

11. A multi-component printed product, the product comprising:
a substrate having an upper surface, an indicia printed on the upper surface;
a layer of ultraviolet primer positioned on the upper surface of the substrate to cover the indicia;
a layer of ultraviolet coating positioned on the layer of ultraviolet primer; and,
a first layer of scratch-off material positioned on the layer of ultravioletcoating.

12. The multi-component product of claim 11 further comprising a second layer of a layer of scratch-off material positioned on the first layer of scratch-off material.

13. The multi-component product of claim 11 wherein the layer of ultraviolet primer is positioned by offset printing equipment.

14. The multi-component product of claim 11 wherein the layer of ultraviolet coating is positioned by offset printing equipment.

15. The multi-component product of claim 11 wherein the first layer of scratch-off material is positioned by offset printing equipment.

16. The multi-component product of claim 12 wherein the second layer of scratch-off material is positioned by offset printing equipment.

17. The multi-component product of claim 13 wherein the layer of ultraviolet primer is positioned to cover the indicia and the entire upper surface of the substrate.

18. The multi-component product of claim 11 wherein the first layer of scratch-off material is releasably positioned on the layer of ultraviolet coating, the first layer adapted for release upon application of a removal force.

19. The multi-component product of claim 12 wherein the second layer of scratch-off material is releasably positioned on the first layer of scratch-off material, the first and second layers adapted for release upon application of a removal force.

20. The multi-component product of claim 12 wherein the first and second layers of scratch-off material are composed of varnish, wax, reducing oil, rice starch, driers, pigments and a drying activator.
